(19) United States
(12) Patent Application Publication
(10) Pub. No.: US 2005/0042593 A1
(43) Pub. Date: Feb. 24, 2005

(54) System and method for providing help/training content for a web-based application

(75) Inventors: Rosalie Marie Hopkins, Norcross, GA (US); Sarah Elizabeth Chodrow, Decatur, GA (US); Kevin Rory Danner, Suwanee, GA (US); Amy Jo Kravitz Thropp, Duluth, GA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ThinkSmart Performance Systems LLC

(21) Appl. No.: 10/948,462

(22) Filed: Sep. 24, 2004

Related U.S. Application Data
(63) Continuation-in-part of application No. 10/742,790, filed on Dec. 23, 2003.
Application No. 10/742,790 is a continuation of application No. 10/151,256, filed on May 21, 2002, now Pat. No. 6,687,485.

(51) Int. Cl. G09B 3/00; G09B 7/00; G06F 9/44; G06F 9/45

(52) U.S. Cl. 434/350; 434/322; 717/124; 717/143

(57) ABSTRACT

A system and method of the present invention supplies a user of a web-based application with relevant interactive help/training content that corresponds to an object or page of the web-based application that the user's cursor is pointing to. The help/training content may include instructions, policies, procedures, tips and other information that may be dynamically updated and delivered to the user. The relevant help/training content may be displayed in a separate window where general information related to a page or pages as well as specific information related to a particular object (e.g., tagged objects, non-tagged objects, media objects, etc.) may be provided.

### CROSS REFERENCE TO RELATED APPLICATIONS

This patent application is a Continuation in Part of U.S. patent application Ser. No. 10/742,790, filed on Dec. 23, 2003 entitled “System and Method for Providing Help/Training Content for a Web-Based Application”, which is a Continuation of U.S. patent application Ser. No. 10/151,256, filed on May 21, 2002, now U.S. Pat. No. 6,687,485 B2 entitled “System and Method for Providing Help/Training Content for a Web-Based Application,” which are also hereby incorporated by reference in their entirety.

### FIELD OF THE INVENTION

The present invention relates to providing help/training content for a web-based application, and is particularly concerned with simultaneously displaying customizable, interactive help/training content in a browser window for an object of a web-based application as the object is triggered in another browser window supporting the web-based application.

Computer-related applications have become increasingly sophisticated and easily accessible over the Internet. As technology advances, new versions and improvements are released periodically with increased frequency. Service providers and other entities are offering more and more applications over the Internet which are easily accessible to all types of users around the world.

With new technology and improved versions of software, users need instructions and oftentimes structured training classes to utilize certain applications effectively. While some applications provide a help module, traditional help programs generally offer static help content that must be requested by the user. Oftentimes, an answer to a particular problem may be difficult to locate, requiring time and effort. In addition, traditional help tools are integrated into a particular piece of software (or application) thereby requiring separate help tools for each new piece of software, including upgrades. As a result, the help/training tool itself becomes obsolete with each new upgrade.

Most companies will provide classroom instruction (e.g., training courses) to introduce a new application or updated version of a familiar application for their employees. Training courses may last a few hours to several days to instruct new users on how to perform daily tasks. Similarly, newly hired employees will also need training for software. Even if a new employee is familiar with a particular application, the new employee will still need to be trained on company policies, procedures and other protocols that may be specific to an employer. The new employee might have a personal instructor stepping through the operation of the computer program, providing the new employee with the policies and procedures for performing tasks (e.g., entering data). However, a personal instructor for each new employee is expensive and time consuming. One way to save costs is to provide training courses periodically (e.g., monthly, quarterly, or semi-annually) for a group of new employees or new users. However, if a new employee is hired during the beginning of this period, the new employee will be unproductive for most of this period until the training course is offered. While training courses are a common way to provide instructions to users, lost production attributed to the company may be enormous and very costly to the company.

In addition, various users have different proficiency levels. While some users may only need a few hours of training to be productive, others may require several days. To offer the same training course to users of varying proficiency results in wasted resources, loss of productivity, and overall frustration.

While companies are one group of users who have a need for an improved training tool, any user may run into difficulties when accessing applications over the Internet. In particular, certain government related forms are difficult to complete correctly and oftentimes require explanation. Frustrated users may give up and be forced to resort to less efficient methods for accessing information.

These and other drawbacks exist with current systems.

### SUMMARY OF THE INVENTION

The present invention is directed to a software solution for web-based training. The present invention provides help/training content, which may include instructions, policies and procedures, and other general and/or customized information to a user while the user is accessing a web-based application system (e.g., PeopleSoft®, SAP®, etc.) delivered using Hypertext Markup Language (HTML), Extensible Markup Language (XML), or any tag-based language. Help/training content may refer to any information or message to be displayed with the web-based application.

The information provided to the user may be context-sensitive, showing the appropriate information at the appropriate time (e.g., when the user needs the information). As the user moves a cursor or mouse pointer over an object of an application in one application window, the help/training content associated with the object is displayed in another window viewable by the user. The relevant help/training content may be associated with a particular object of the application so that even if the object is later repositioned, altered in size or shape or otherwise modified, the relevant help/training content will be nevertheless displayed to the user when the object is triggered (e.g., by moving a cursor over the object). Thus, in this example, the help/training content is not pixel-based, but rather defined at an object level. In another embodiment, the help/training content may be displayed depending on a location of an object as well. In addition, the help/training content provided to the user may be based on a particular page (or pages) of the web-based application. Further, help/training content may also be applied to the entire web-based application.

According to another embodiment of the present invention, the user is not required to request help/training content for certain objects or fields within an application. Rather, appropriate help/training content may be automatically provided to the user as the user triggers certain objects or fields (e.g., by moving a pointer or cursor over the object or field within the page of the web-based application using a mouse or other device). Therefore, the user is not required to invoke a help/training tool, nor is the user required to search through a table of contents or submit terms for a word search. For example, for topics familiar to a user, a quick scan of the relevant help/training content may be sufficient. However, for unfamiliar topics of areas that may need further explanation, a user may examine the relevant help/training content in greater detail. In addition, additional links and/or tabs of additional information may be explored. Thus, the user may proceed through an application at his or her own pace with an amount of help/training content sufficient for the individual user.

The help/training tool of the present invention may be separate from the web-based application so that the application as viewed by the end user does not appear altered or modified. In addition, the help/training tool may work with a variety of different applications. For example, help/training content associated with an object across multiple applications may be displayed to a user. If a user is running multiple applications concurrently, the help/training tool of the present invention may display relevant help/training content for multiple applications depending on where the user's cursor is currently located (e.g., over what object in what application). For example, as a user navigates through a browser, the content displayed in a content window may change accordingly. In another example, multiple browser windows may support multiple web-based applications. While a user may be positioned in a first browser window. The content shown in the content window may change as the user toggles among different browser windows supporting different applications.

The present invention may be utilized by companies, software vendors, and other entities. For example, the application may be used with in-house and vendor-delivered systems. The present invention may by used by software vendors to provide general training for their applications. In addition, consultants may provide custom training to the vendors' end-users. However, no cooperation from a software vendor may be required for tag-based, web-delivered packages, for example. Therefore, end-user companies may work with the present invention with little or no assistance from the original software vendor. The present invention may also be used to provide consulting, implementation, and training on how to develop customized help/training content.

According to an embodiment of the present invention, a web-based Electronic Performance Support System (EPSS), running on Linux, Windows NT™ or other operating systems may be provided. The present invention may implement a combination of a proxy server, database server, and a Web server to deliver help/training content to a user simultaneously with the web-based application. One embodiment of the present invention comprises a network-based (e.g., Internet, Intranet, etc.) tool that takes an application in a tag-based language, such as HTML, XML, or other language and instruments it with on-line, interactive, help/training content.

According to another embodiment of the present invention, a content management window enables a content developer (or other user) to develop help/training content and insert the content into a database. For example, a content developer (or other user) may create content and associate the content with objects (e.g., input fields, buttons, lists, links, etc.) in a web-based application. The content management window may run with the application or without the application. For example, when new content is being created for an application, the application may run while content is being associated with tagged objects. In another example, if a minor correction is being performed, an edit may be performed to the content without running the application.

According to an embodiment of the present invention, a computer implemented method for associating content with one or more application objects comprises the steps of intercepting an application page from an application server to a client browser for displaying the application page; identifying one or more application objects associated with the application page, wherein the one or more application objects comprise one or more of tagged objects and non-tagged objects; identifying the one or more application objects wherein the one or more applications objects are associated with content by an object identifier; associating the object identifier to the one or more application objects; and sending the application page to the client browser wherein an appropriate content identified by the object identifier is displayed when an associated application object is triggered in the application page displayed on the client browser.

According to an embodiment of the present invention, a method employed by a computer user for accessing content associated with one or more application objects comprises the steps of accessing an application page from an application server, wherein the application page is intercepted by a proxy server, prior to displaying the application page on a client browser; wherein the proxy server identifies one or more application objects associated with the application page, the one or more application objects comprising one or more of tagged objects and non-tagged objects, wherein the proxy server identifies the one or more application objects wherein the one or more applications objects are associated with content by an object identifier; triggering an application object displayed on the application page on the client browser; and viewing content identified by the object identifier when the associated application object is triggered.

According to an embodiment of the present invention, a computer implemented method for associating content with an application comprises the steps of loading an application page through a proxy server; embedding javascript in the application page for activating a content window; verifying that a media object is present and a help/training tool is enabled; loading the media object through an additional media object that implements an API; and displaying context sensitive content in the content window in response to a user input in the media object.

The accompanying drawings, which are incorporated in and constitute a part of this specification, illustrate various embodiments of the invention and, together with the description, serve to explain the principles of the invention.

### BRIEF DESCRIPTION OF THE DRAWINGS

The present invention can be understood more completely by reading the following Detailed Description of the Invention, in conjunction with the accompanying drawings, in which:

FIG. 1 illustrates a system for providing help/training content for a web-based application, according to an embodiment of the present invention.

FIG. 2 is a flowchart for accessing help/training content for a web-based application from a user's perspective, according to an embodiment of the present invention.

FIG. 3 is a flowchart illustrating a help/training content request process, according to an embodiment of the present invention.

FIG. 4 is an example of an application window and a content window, according to an embodiment of the present invention.

FIG. 5 is a flowchart illustrating management of help/training content for a web-based application, according to an embodiment of the present invention.

FIG. 6 is a flowchart illustrating a content management process, by which tagged objects are presented to a user, according to an embodiment of the present invention.

FIG. 7 is a flowchart illustrating actions that may be taken with tagged objects relevant to a help/training system, according to an embodiment of the present invention.

FIG. 8 is a flowchart illustrating a content management process by which content may be associated with selected objects, according to an embodiment of the present invention.

FIG. 9 is an example of a form objects window, according to an embodiment of the present invention.

FIG. 10 is an example of a link objects window, according to an embodiment of the present invention.

FIG. 11 is an example of a content search window, according to an embodiment of the present invention.

FIG. 12 is a flowchart illustrating management of content for a web-based application with objects, including tagged and/or non-tagged objects, according to an embodiment of the present invention.

FIG. 13 is a flowchart illustrating an API to an exemplary Flash application, according to an embodiment of the present invention.

FIG. 14 is a flowchart illustrating implementation of a help/training tool with an exemplary Flash application, according to an embodiment of the present invention.

FIG. 15 is an example of defined Flash objects, according to an embodiment of the present invention.

FIG. 16 illustrates a system for providing help/training content for a web-based application, according to an embodiment of the present invention.

FIG. 17 is an exemplary template for automatic documentation generation, according to an embodiment of the present invention.

### DETAILED DESCRIPTION OF THE INVENTION

The following description is intended to convey a thorough understanding of the invention by providing a number of specific embodiments and details involving a system and method for providing help/training content for a web-based application. It is understood, however, that the invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

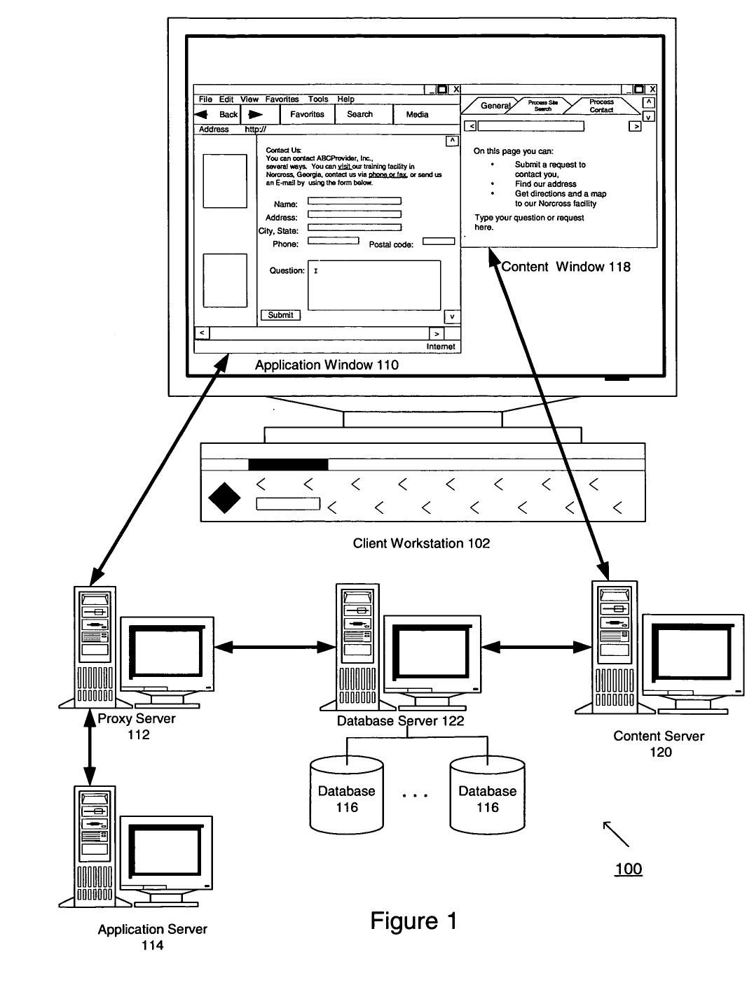

FIG. 1 illustrates a system for providing help/training content for a web-based application, according to an embodiment of the present invention. System 100 may include a client browser for displaying an application window 110 that supports a web-based application which may be accessed over the Internet or a company's Intranet (or other network). The application may be developed using JAVA, PHP, HTML, XML, mySQL, javascript, ActiveX and/or any other language. Application window 110 may be in communication with a proxy server 112. Proxy server 112 may be in communication with an application server 114 and a database server 122. Database server 122 may manage and maintain database 116, which may include a plurality of databases where the plurality of databases may be located at a single location or multiple locations. While having access to application window 110, a user may simultaneously view help/training content on a content window 118. Content window 118 may be in communication with a content server 120, which may be in communication with database server 122. While the servers are illustrated as being separate, the functionality associated with each server may be combined. For example, functionality associated with the servers shown in FIG. 1 may be combined into one server or multiple servers, which may reside at a single location or multiple locations.

Application window 110 and content window 118 may be supported by a client workstation 102, such as any desktop device, computer, personal digital assistant (PDA) or other device capable of accessing the Internet or a company's Intranet (or other network), including wireless/mobile devices. According to an example, the application window and the content window may be displayed on a single device. In another example, while an application is running on application window 110, content window 118 may be displayed on a separate device, e.g., another computer, PDA, a mobile device, or other device capable of communication via the Internet, for example. In another example, content delivered via content window 118 may include sound, animation, graphics and/or other user interfaces. For example, content window 118 may provide content information with sound where content information may be heard by the user.

Proxy server 112 may function as an engine to enable the display of developed training, side by side with the application. Proxy server 112 allows an application to be enhanced with help/training content identifiers, while leaving the functionality of the application intact. Application server 114 delivers the application (e.g., an application page) for display by a client browser to the user.

According to an embodiment of the present invention, content window 118 may display content associated with a page, object, or other element triggered in an application supported by application window 110. According to another embodiment of the present invention, content window 118 may enable a content developer (or other user) to store objects in a database as well as associate content with those objects. This function may be performed while running an application or without running an application.

Content server 120 may supply the user with help/training content, which may include instructions, policies, procedures and/or other information that may be delivered in a tag-based language, such as HTML, XML, format or via a Uniform Resource Locator (URL) link through a browser window, for example. Content server 120 may retrieve help/training content (and/or other information) from database 116, through database server 122, and send the content to the content window 118 where it may be displayed to the user. Help/training content may contain HTML, Graphics, Flash™ movies, CBT and/or anything that may be linked to and called from HTML (or other tag-based languages).

Content window 118 allows content developers (and/or other users) to insert help/training materials (and/or other information) into database 116, through database server 122. The content window 118 may allow help/training content developers (and/or other users) to create training objects and associate them with mousable items on a screen (e.g., input fields, buttons, lists, links, etc.).

Database server 122 may hold one or more Structured Query Language (SQL) database, relational database or other type of database, as represented by database 116. A database server 122 may store help/training content (and/or other information) and associated objects. Database server 122 may save content created by content window 118.

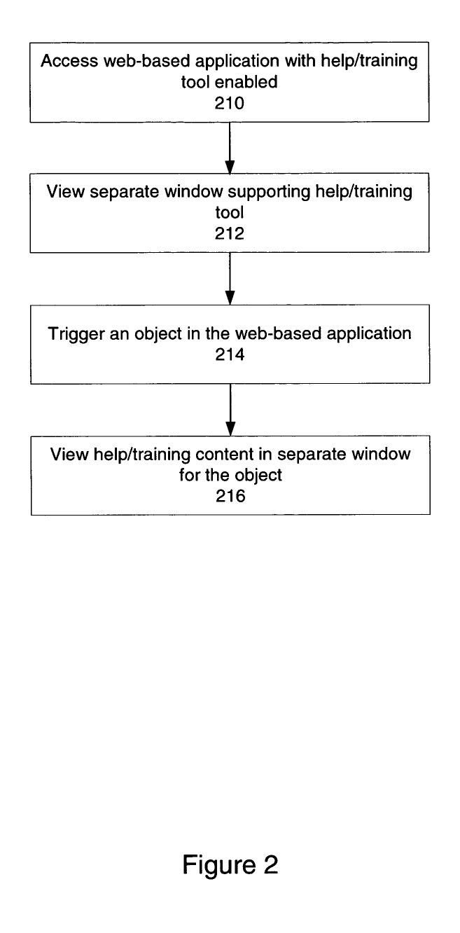

FIG. 2 is a flowchart for accessing help/training content for a web-based application from a user's perspective, according to an embodiment of the present invention. At step 210, a user may access a web-based application via the Internet or a company's Intranet (or other network) with the help/training tool enabled. The application may be delivered using HTML, XML or another language that utilizes tags. At step 212, a separate window for displaying interactive help/training content provided by the help/training tool of the present invention may be provided to the user. At step 214, the user may maneuver a mouse pointer, cursor, or other device over various objects (e.g., fields, data input, graphics, links, etc.) of the web-based application. By moving a mouse pointer over a particular object, the help/training tool may simultaneously display corresponding help/training content associated with the particular object in the separate window, at step 216. Other methods for triggering or invoking an object of the web-based application may be implemented. Therefore, rather than requiring the user to request specific help/training content, the present invention tracks the user's actions (e.g., by a cursor, mouse or other pointer) and simultaneously provides relevant help/training content.

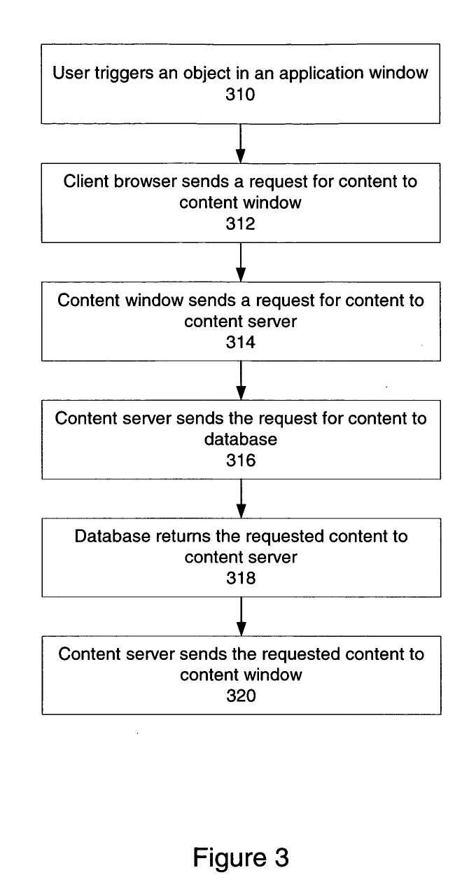

FIG. 3 is a flowchart illustrating a help/training content request process, according to an embodiment of the present invention. At step 310, a user may trigger an object (e.g., input field, button, drop-down, link, etc.) in an application window, supported by a client browser. For example, a user may move a mouse in an object window or a user may position a cursor over an object or word. Other methods for activating an object may be implemented. At step 312, the client browser may send a request for content (e.g., a help/training content identifier) to a content window. At step 314, the content window may send the request for content to a content server. At step 316, the content server may send the request for content to a database server. At step 318, the database server may return the requested content (e.g., training content associated with the triggered object) to the content server. At step 320, the content server may send the requested content to the content window for simultaneous display with the application window.

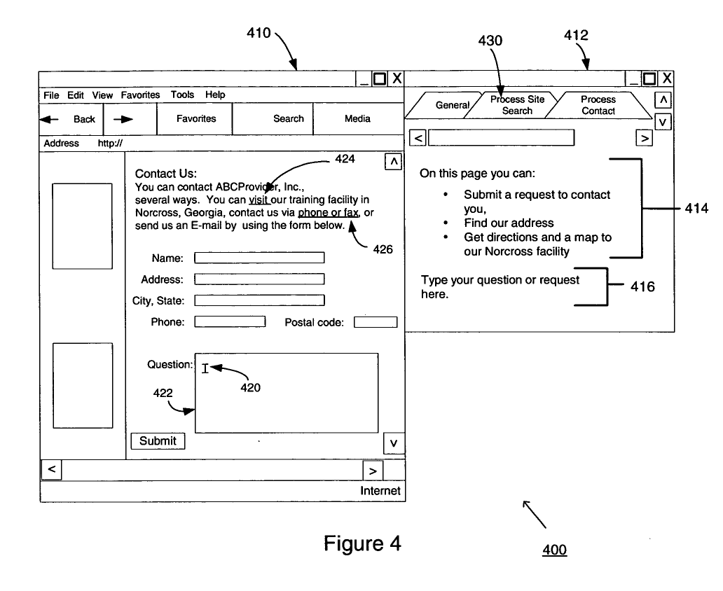

FIG. 4 is an example of an application window and a content window, according to an embodiment of the present invention. Application window 410 may display a web-based application that may be accessed by a URL (or other identifier or address). Content window 412 may display help/training content associated with the page displayed in Application window 410. Content window 412 may provide general information associated with the page, as shown by 414, as well as specific information related to a particular object, as shown by 416. As the user moves a cursor (or other pointer) around the page, content window 412 may display help/training content corresponding to an object to which the cursor is currently pointing. For example, cursor 420 is shown in Question box 422. Accordingly, help/training content associated with Question box 422 is displayed in content window 412, at 416. Content window 412 may display available options, functions, instructions, policies and/or other information associated with the corresponding object or page in the Application window 410. As the user moves cursor 420 to a different object, the content in window 412 may change to correspond to that object.

Help/training content may also be displayed for hyperlinks and other objects. For example, when cursor 420 points to hyperlinks “visit” 424 or “phone or fax” 426, content window 412 may display corresponding information related to these hyperlinks.

Content window 412 may also provide interactive content. For example, various tabs, as shown by 430, may be available to provide additional or more detailed information. For example, tabs 430 may provide content such as process descriptions, useful links, policies, etc. These tabs may be customized to deliver easily accessible information that may be updated dynamically in real time.

According to another embodiment of the present invention, the help/training tool of the present invention enables users to create content dynamically for various objects and/or pages of a web-based application.

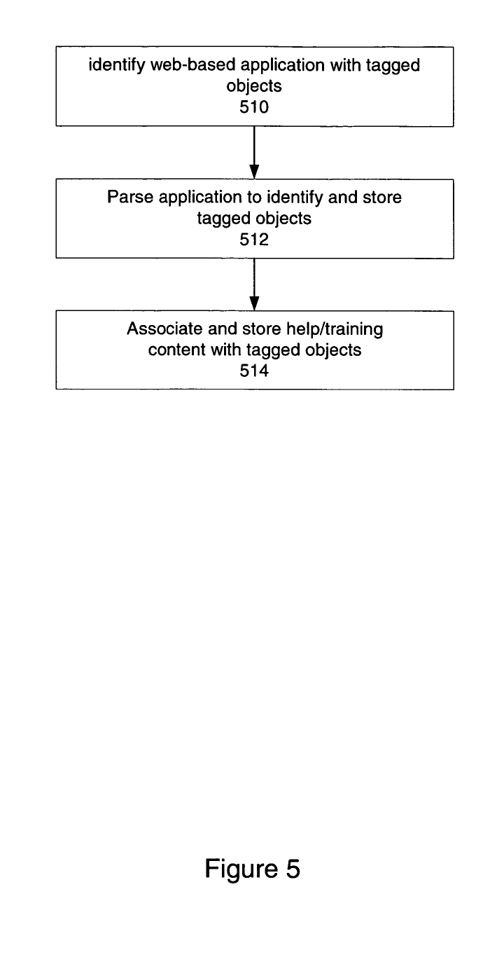

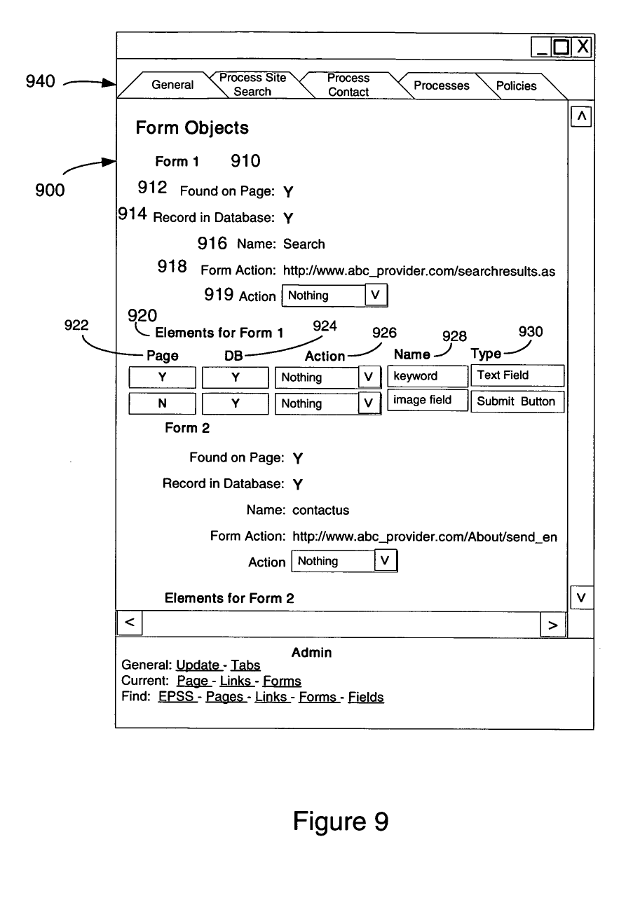

FIG. 5 is a flowchart illustrating management of help/training content for a web-based application, according to an embodiment of the present invention. At step 510, a web-based application may be identified and/or accessed. The web-based application may generally contain various objects (e.g., elements, tags or other identifiers). The web-based application may be delivered using HTML, XML, or another tag-based language. Help/training content may be stored and associated with particular tags. When the tag is triggered, the associated help/training content may be displayed. Since help/training content may be associated with a particular tag in the application, even if an object (e.g., an input box) is moved to a different location, the appropriate help/training content still may be displayed. For example, moving the cursor to an object may generate an event that calls an appropriate help function. At step 512, the web-based application may be parsed to identify tagged objects and store object identifiers in the database, as shown in further detail in connection with FIGS. 9, 10, and 11. At step 514, help/training content may be associated with the identified object identifiers and stored in the database. Help/training content may include instructions, explanations, tips, policies, protocols and/or other information relevant to a particular object, group of objects, page, or pages of the web-based application. The help/training content may be displayed to a user when an associated object in the web-based application is triggered. According to the present invention, the functionality of the web-based application itself is not compromised or modified. Furthermore, the application is not required to change to make use of the present invention.

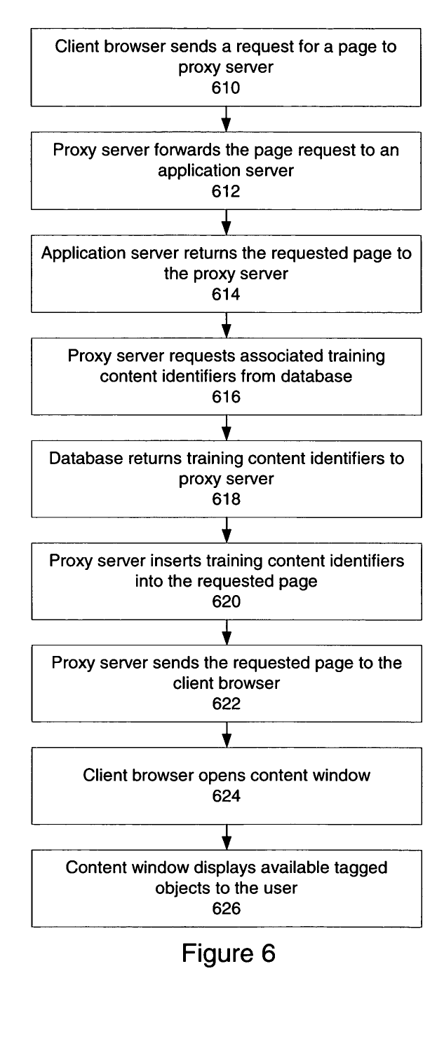

FIG. 6 is a flowchart illustrating a content management process, by which tagged objects may be presented to a user, according to an embodiment of the present invention. An application may be run through a proxy server so that a content window may detect tagged objects. The present invention may allow a content developer to store the tagged objects in a database. At step 610, a client browser may send a request for an application page to a proxy server. At step 612, the proxy server may forward the page request to an application server. At step 614, the application server may return the requested page to the proxy server. At step 616, the proxy server may request help/training content identifiers associated with the requested page from a database server. At step 618, the database server may return the help/training content identifiers to the proxy server. At step 620, the proxy server may annotate the requested page with help/training content identifiers. At step 622, the proxy server may send the annotated page to the client browser. At step 624, the client browser may open a content window. At step 626, the content window may display available tagged objects to the user.

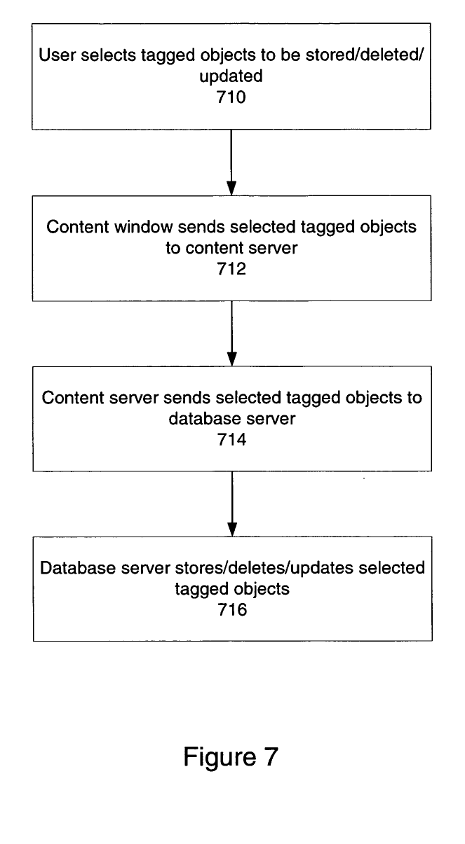

FIG. 7 is a flowchart illustrating actions that may be taken with tagged objects relevant to a help/training system, according to an embodiment of the present invention. At step 710, a user may select one or more tagged objects to be stored, deleted and/or updated. Other user-defined or user-selected actions may be performed. At step 712, a content window may send one or more selected, tagged objects to a content server. At step 714, the content server may send one or more selected, tagged objects to a database server. At step 716, the database server may store, delete and/or update one or more selected, tagged objects. Other actions requested by the user may be performed.

The content window may run with the application or without the application. For example, when new content is being created for an application, the application may run while content is being associated with tagged objects. In another example, if a minor correction is being performed (e.g., a one-word correction), an edit may be performed to the content without running the application.

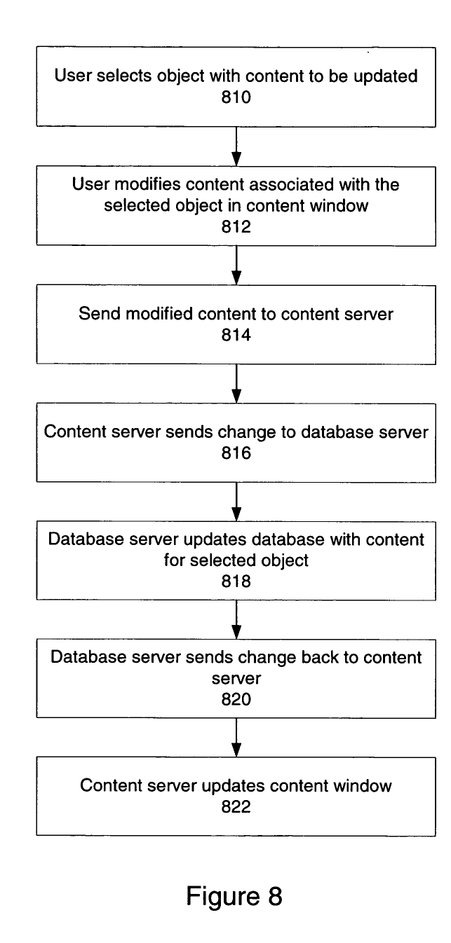

FIG. 8 is a flowchart illustrating a content management process by which content is associated with selected objects, according to an embodiment of the present invention. At step 810, a user may select an object with content to be updated. Other user-defined or user-selected actions may be performed. At step 812, the user may modify (e.g., add, update, or delete) the content associated with the selected object in the content window. At step 814, the modified content may be sent to a content server. At step 816, the content server may send the change to a database server. At step 818, the database server may update the database with content for the selected object. At step 820, the database server may send the change back to the content server. At step 822, the content server may update the content window.

FIG. 9 is an example of a form objects window, according to an embodiment of the present invention. The present invention may automatically scan an application (e.g., a page, multiple pages, a portion of a page, an entire application, or other application-defined section, etc.) to identify tagged objects and/or other elements of an application. The present invention may further determine whether existing content has been previously defined for an object and whether new content should be defined (or updated) for an object. Therefore, the present invention simplifies a process of associating content with objects or pages of a web-based application. FIG. 9 illustrates results of a scan of a page of an application, as shown in content window 900. As indicated in section 910, a form object with the name “search” as shown by 916 has been found on the page, as shown by 912. This object may have been stored in the database, as shown by 914. In addition, a form action may be described at 918. A form action represents an action taken by the web-based application when the user submits data to the application. The user may use a drop-down menu (or other user input), at 919 to save the object to the database, create a new object, delete the object from the database, modify the object and/or content in the database, or take no action (e.g., apply content found in the database). Other options may be available.

Elements associated with the object of Form 1 may be shown at section 920. Whether the elements are found on the page and the database are displayed in columns 922 and 924, respectively. A user may select an action from the drop-down menu at column 926. Element name and type may be shown in columns 928 and 930, respectively.

Tabs 940 may be defined and customized in the present invention. The information provided in the tabs may change dynamically depending on the page, object, or other element where the user's cursor is currently placed. A general tab may provide help/training content to a user for a page, an object, or other predefined element. A policy tab may provide page-level information, notes, and/or other information. Other tabs may be customized based on the type of application, type of user, and/or other factors. For example, if the application is a data-entry application, a tab may be provided for detailing data entry procedures. In addition, a content developer may use the present invention to deliver warnings and other information to users in real time. For example, if a company wants to recall a particular product or issue a warning, the company may provide a message that will appear in a content window when a user accesses the corresponding web-based application. Warning information may be provided as a tab or as an instant message box. Other graphics (e.g., icons, animation, etc.) may be implemented to display content and other information. In addition, sound (e.g., speech, music, etc.) as well as video may be used to convey content.

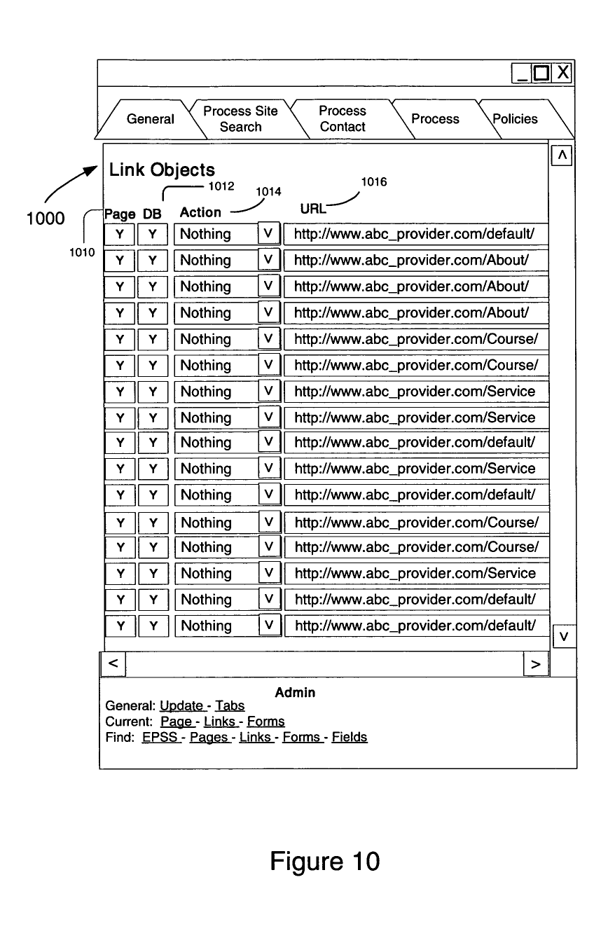

FIG. 10 is an example of a link objects window, according to an embodiment of the present invention. For example, the links objects window 1000 provides a listing of hyperlinks found on a page of a web-based application. Whether an object is found on a particular page is shown in column 1010. Whether the object exists in the database is shown in column 1012. A user action may be defined in column 1014, and a corresponding URL may be displayed in column 1016. Other information may be provided as well.

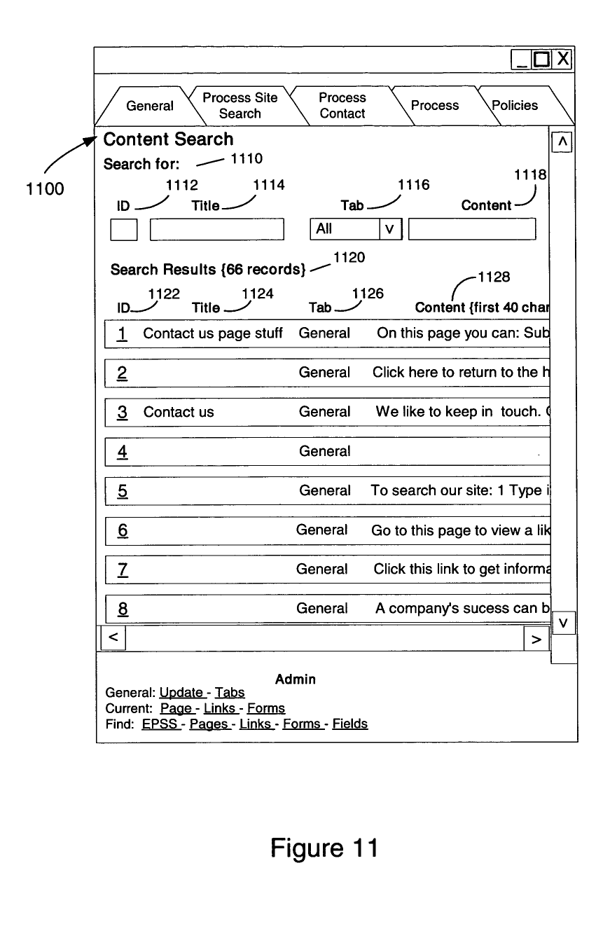

FIG. 11 is an example of a content search window, according to an embodiment of the present invention. Content search window 1100 may include Search 1110 and Search Results 1120. Search 1110 enables a user to search for a particular object or objects based on ID 1112, title 1114, tab 1116 and/or content 1118. In another example, user-defined search terms may be used. Search results 1120 may be displayed by ID 1122, title 1124, tab 1126 and/or content 1128.

The present invention may replace classroom instruction for many employees. Rather than spending a week in class to learn how to perform daily tasks, a new user may be able to run an application from the user's desk and have concurrent training, as the user is using the system.

With the present invention, a new user may be given instructions on how to start the application and the help/training tool of the present invention. From there, the present invention may provide step-by-step help on how to enter data, how to navigate through the system, and help on company policies and procedures. Thus, the new user may be productive from day one without classroom training.

The present invention provides additional benefits and features. As the present invention is web-delivered, content may be centrally served, updated and disseminated immediately without physical distribution of a knowledge base. Because the help/training content of the present invention may be customized, internal Subject Matter Experts may provide information that may become immediately available to application users. Internal knowledge may be made available to some or all users. In addition, the present invention content window may be branded for any customer, making it look as though it were developed in-house or especially for a specific audience. The present invention may work without any modifications to the application (as viewed by the end user) or assistance from the application vendor, provided the application is delivered using a tag-based language. The functionality of the application is unaffected by the presence of the content window. The application runs as if the help/training tool is not present.

Even if an application is presented in one language, the present invention window may be displayed in any language. Content can be developed for multiple languages supporting an application in a particular language. Therefore, the present invention may display a translation of terms and/or phrases corresponding to an object in a web-based application. According to another embodiment of the present invention, content may be delivered as sound, so instructions may be heard by the user.

The present invention may provide multiple levels of security. A first level of security may provide secure access to the help/training content for the purposes of viewing or modifying content. For example, users may be granted the right to add, change, or delete help/training content. In another example, users may only be able to view the content. Other privileges may be available and other restrictions may be applied. A second level of security may apply to the application and the associated help/training content. Since the content tracks with the application, the help/training content may mirror whatever security access to the application is in place. If end-users do not have access to a particular function, they will not see any training associated with that function.

According to an iteration of the present invention, content may be displayed while the user accesses a media element (e.g., Flash™ movie, Java Applet, etc.) by providing an Application Program Interface (API) for developers to use while creating various media objects. Media objects may also refer to other non-tagged objects. In some cases, media objects may contain open and well understood standards, such as Flash ™ and others. Content may be displayed for media objects by modifying the media object during development to implement a specified API, thus allowing the media object to generate events that trigger content display.

As discussed above, FIG. 1 illustrates a system for providing content for a host application, according to an embodiment of the present invention. According to another iteration of the present invention, the system may display content in the content window for application objects, including tagged objects and/or non-tagged objects. Exemplary objects may include Flash movies, Java Applets, ActiveX controls, and/or other types of media. According to an exemplary scenario, an embodiment of the present invention may provide an API for application developers (or other users) to implement while coding the application with tagged and/or non-tagged objects. Through the API, the system of an embodiment of the present invention may recognize non-tagged objects and/or other elements and objects. A content server 120 may interpret exposed interface points and apply appropriate content mappings based on the API. The API provides the mechanism for the media object to expose the needed information so that the content server 120 may display the associated content. A content server 120 may retrieve and display the information based on a related API.

Application developers may be provided with a software development kit (SDK) that includes documentation on how to implement the API, thus exposing what may be needed to recognize objects in the host application. The SDK may also provide a library with various extensible functions to facilitate implementation of the API in the host application.

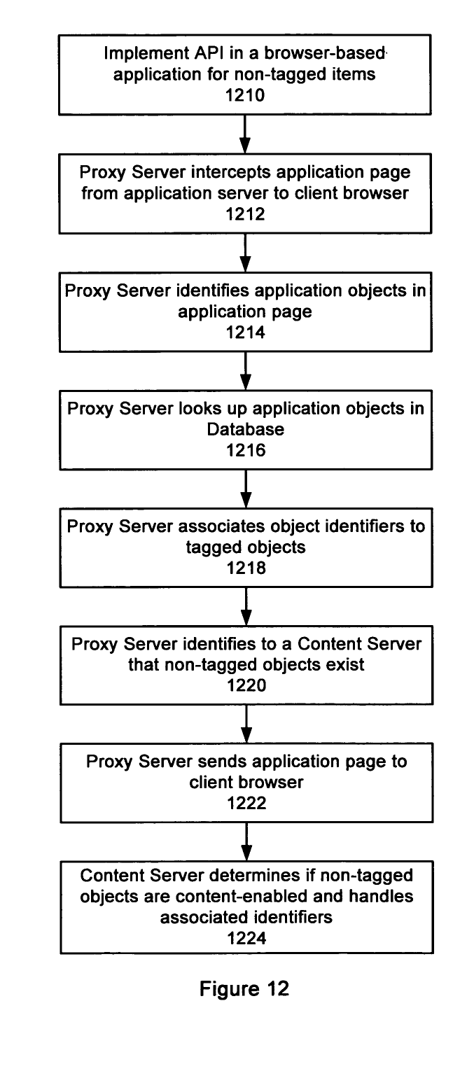

FIG. 12 is a flowchart illustrating management of content for a web-based application with objects, including tagged and/or non-tagged objects, according to an embodiment of the present invention. At step 1210, an application programmer (or other user) may implement an API in a browser-based application (e.g., host application) for non-tagged objects. At step 1212, a proxy server may intercept an application page of the host application as the page goes from an application server for the host application to a web-browser at a client site. At step 1214, the proxy server may identify application objects including one or more tagged and/or non-tagged objects in the application page of the host application. These application objects may be objects with the potential to have content associated with them. At step 1216, the proxy server may look up the application objects (including tagged and/or non-tagged objects) to determine if the application objects exist. The application objects may be stored in a database, or other type of memory or storage mechanism. At step 1218, the proxy server may associate object identifiers to the tagged objects, as discussed in detail above. At step 1220, the proxy server may identify to a content server that non-tagged items exist. At step 1222, the proxy server may then send the application page with the appropriate object identifiers to the client browser. At step 1224, the content server may then determine if non-tagged objects are content-enabled and handle the associated identifiers.

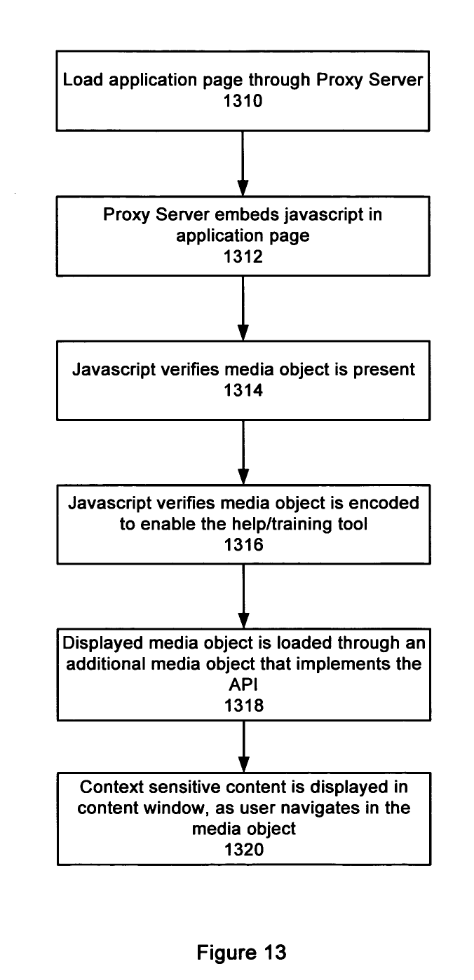

FIG. 13 is a flowchart illustrating an API to an exemplary Flash application, according to an embodiment of the present invention. At step 1310, an application page may load through a proxy server. At step 1312, the proxy server may embed javascript in the application page for activating the help/training tool of an embodiment of the present invention. At step 1314, the javascript may verify that a media object, such as a Flash movie, is present. At step 1316, if a media object (e.g., a Flash movie) is present, the javascript may verify that the help/training tool of an embodiment of the present invention is enabled in the media object. For example, javascript may verify that that Flash object is encoded to enable the help/training tool. At step 1318, if the help/training tool is enabled, the displayed media object (e.g., Flash movie) may be loaded through an additional media object (e.g., Flash movie) that implements the API. This media object (e.g., Flash movie, etc.) may provide the API that allows the help/training tool know where user input and/or user actions. For example, the API may allow the help/training tool to know where a user is in the media object and where the mouse is located. Other user input/actions may be recognized. At step 1320, as the user navigates through the media object, corresponding context sensitive content may be displayed in the content window in response to the user's actions/inputs. While the above exemplary embodiment discusses a Flash media object, the steps of FIG. 13 may also be applied to other media objects and other non-tagged objects.

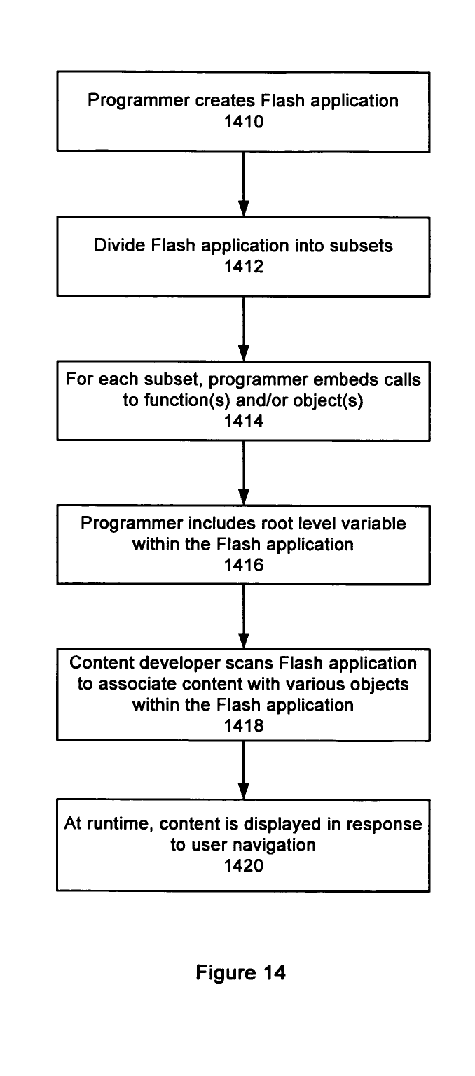

FIG. 14 is a flowchart illustrating implementation of a help/training tool with an exemplary Flash application, according to an embodiment of the present invention. At step 1410, a programmer (or other user) may create or otherwise obtain a Flash application. Other applications may be created, accessed or obtained as well. At step 1412, the Flash application (or other application) may be divided into subsets. For a Flash application, the application may be divided into scenes within a Flash timeline. Other logical groupings may be realized. At step 1414, for each subset, the programmer may embed calls to functions and/or objects. For example, in the first frame of each scene, the programmer may embed calls to functions that define the page and/or objects on the page. A function call may provide an API to the help/training tool. Another function call may provide a list of application objects with the potential for content association. Other function calls may be defined for other purposes. At step 1416, the programmer may include a root level variable within the Flash application. The root level variable may be triggered, which the help/training tool may use to turn itself on. Other variables may also be included within the Flash application. At step 1418, a content developer (or other user) may scan the Flash application interactively using the help/training tool of an embodiment of the present invention and associate content with the various objects within the Flash application. At step 1420, at runtime, content may be displayed in response to user navigation as well as other user inputs/actions. For example, content may appear when the user navigates from page to page for page-level content or mouse over predefined objects for object-level content. Other elements may be triggered for various types of content.

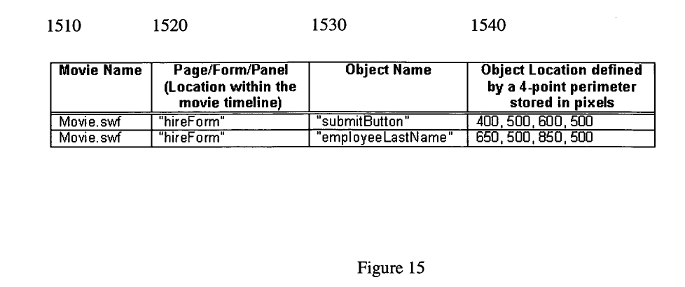

FIG. 15 is an example of defined Flash objects, according to an embodiment of the present invention. For an exemplary Flash application, movie name 1510, page/form/panel 1520, object name 1530 and object location 1540 may be identified. Page/Form/Panel 1520 may refer to location within the movie timeframe. Object Location 1540 may be defined by a 4-point perimeter stored in pixels. Other ways to identify an object location may also be implemented. Other Flash objects, media objects and/or non-tagged objects may be identified as well. For other applications, different objects may be identified and defined.

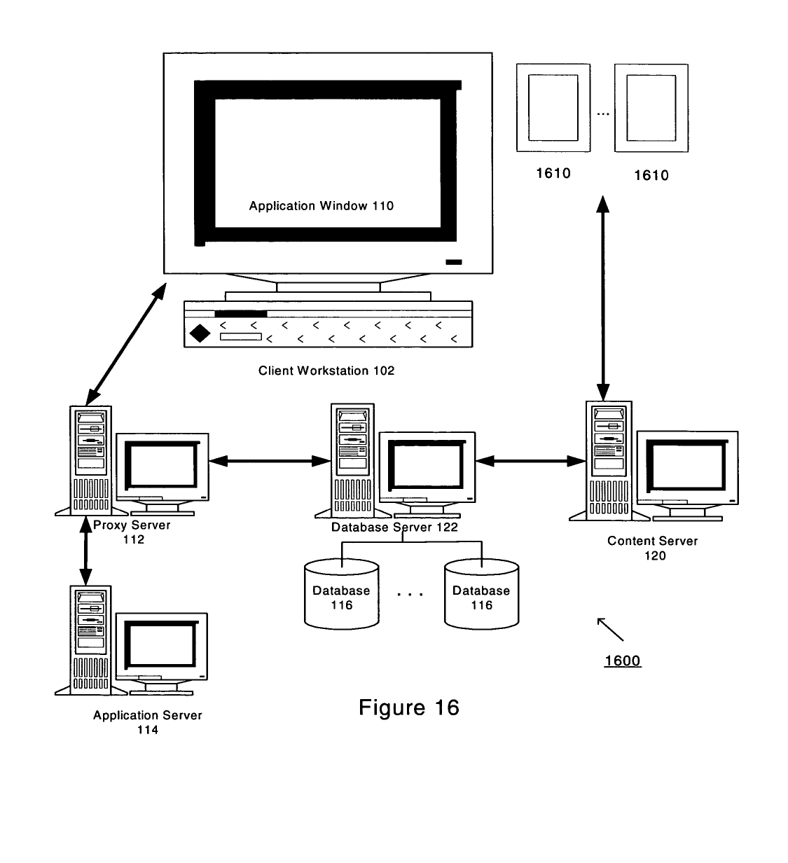

When the user triggers an application object in the application page at the client site, a content server may display associated content. The content may be displayed as a second window, as embedded content, at a remote device and/or according to other display options. FIG. 16 illustrates a system for providing help/training content for a web-based application, according to an embodiment of the present invention. System 1600 may include a client browser for displaying an application window 110 that supports a web-based application which may be accessed over the Internet, a company's Intranet (or other network) and/or other communication medium. The application may be developed using JAVA, PHP, HTML, XML, javascript, ActiveX and/or any other language. Application window 110 may be in communication with a proxy server 112. Proxy server 112 may be in communication with an application server 114 and a database server 122. Database server 122 may manage and maintain database 116, which may include a plurality of databases where the plurality of databases may be located at a single location or multiple locations. In addition, other memory or storage mechanism may be implemented. While having access to application window 110, a user may simultaneously view help/training content, which may be displayed at client workstation 102, a remote device and/or other display device. The display of content may be provided by a content server 120, which may be in communication with database server 122. While the servers are illustrated as being separate, the functionality associated with each server may be combined. For example, functionality associated with the servers shown in FIG. 16 may be combined into one server or multiple servers, which may reside at a single location or multiple locations.

Application window 110 may be supported by a client workstation 102, such as any desktop device, computer, personal digital assistant (PDA) or other device capable of accessing the Internet or a company's Intranet (or other network), including wireless/mobile devices. According to an example, the application window and content may be displayed on a single device. In another example, while an application is running on application window 110, content may be displayed on a separate device, as shown by 1610, e.g., another computer, PDA, a mobile device, or other device capable of communication via the Internet, for example. In another example, content delivered via a content window may include sound, animation, graphics and/or other user interfaces. For example, content may be provided with sound where content information may be heard by the user.

Proxy server 112 may function as an engine to enable the display of developed help/training or other content, with the application. Proxy server 112 allows an application to be enhanced with help/training content identifiers, while leaving the functionality of the application intact. Application server 114 delivers the application (e.g., an application page) for display by a client browser to the user.

According to an embodiment of the present invention, content server 120 may provide content associated with a page, object, or any other element triggered in an application supported by application window 110. According to another embodiment of the present invention, a content developer (or other user) may store objects (e.g., tagged and/or non-tagged) in a database as well as associate content with those objects. Other memory or storage mechanisms may be implemented. This function may be performed while running an application or without running an application.

Content server 120 may supply the user with help/training content, which may include instructions, policies, procedures and/or other information that may be delivered in a tag-based language, such as HTML, XML, or other format or via a Uniform Resource Locator (URL) link through a browser window, for example. Content server 120 may retrieve help/training content (and/or other information) from database 116, through database server 122, and send the content to be displayed to the user (or other intended recipient) with the application at 102 or at a remote device 1610. In addition, content server 120 may access help/training content through other storage mechanisms, which may or may not include a database. Help/training content may contain HTML, Graphics, Flash™ movies, CBT and/or anything that may be linked to and called from HTML (or other languages).

Content developers (and/or other users) may insert help/training materials (and/or other information) into-database 116, through database server 122. Help/training materials or other content may also be stored or accessed from other memory or storage mechanisms. Help/training content developers (and/or other users) may create training objects and associate them with mousable items on a screen (e.g., input fields, buttons, lists, links, etc.) or loadable items (e.g., pages, applications, etc.).

Database server 122 may hold one or more Structured Query Language (SQL) database, relational database or other type of database, as represented by database 116. A database server 122 may store help/training content (and/or other information) and associated objects (e.g., tagged and/or non-tagged). Database server 122 may save content created via content server 120. Other memory or storage mechanisms may be implemented.

Content server 120 may look up object identifiers in a database 116 through database server 122 and display appropriate content, based on what proxy server 112 identified. In addition, object identifiers may be accessed through other means. Content may be displayed as the user passes the mouse over the application objects in the host application window 110 as described in detail above. Other inputs and/or actions may trigger display of content.

As discussed above, an iteration of the present invention may deliver content without opening a second window next to the application window. For example, the content may be embedded within the application page, as text, audio, layers, alt text, other HTML-capable object, etc. In another example, the content may be delivered to a separate device (e.g., phone, PDA, television, text pager, help desk, different computer, etc.) instead of or concurrently with the delivery to the application window. Content may be delivered simultaneously or after a predetermined time, depending on the application. The content may also be delivered in different formats (e.g., font, size; color, language, animation, etc.).

As text or other HTML-capable object, an embodiment of the present invention may display additional text, graphics, or other media on the host application page that would explicate the host application's fields, forms, links, etc., thereby adding content to the actual application page. Content may be built-into the associated web page.

As audio, an embodiment of the present invention may record content in a web-compatible media format and deliver the content as audio when the user mouses over or tabs into associated tagged and/or non-tagged objects. Other inputs and/or actions may trigger the display of content.

By using layers and taking advantage of HTML layers, content may appear in the host application page in a separate layer, so that the host application's look and feel may appear unmodified where content may be displayed on top of the host application.

Using alt text, content may be embedded in the host application so that when the mouse hovers over associated html-tagged objects (or other object), text may appear in a box (or other interface or graphic) and disappear when the mouse moves away from that object. Alt text may refer to a text block that appears when a cursor hovers over a field. Other graphics may be used to display the text. In another example, a sound file or other media format may present the content. Other formats for delivering content may be implemented. Other triggering events may be identified.

One or more separate devices may be used to display associated content. For example, the content may be delivered to a device other than or concurrently with the content window. The device may include any device capable of displaying content, such as a phone/text pager, PDA, television, other wireless/mobile devices, etc., represented in FIG. 16 as 1610. The elements of FIG. 16 are described in further detail in connection with FIG. 1 above. In addition, the content may be simultaneously displayed to multiple devices. In another example, separate content may be delivered to specific devices. The content delivered to a certain device may be different than the content delivered to another device, based on limitations, such as device format, user preference, etc. For example, the content delivered to a phone or text pager may be redacted or otherwise abbreviated due to the small display screen. In addition, certain icons and graphics may be turned off as well. Depending on the intended recipient, confidential data may be redacted, replaced or otherwise hidden. According to another example, the devices may be connected to the Internet and have a web browser installed. When the user navigates in the host application at 110, the content will appear on the external device's display, as shown by 1610.

Another iteration of the present invention provides for tight integration with the host application. This may be accomplished by using field values as part of the context. In another example, content may be associated with non-interactive parts of the application page. The proxy server 112 provides for annotation to text and other areas. User and/or security information associated with the underlying application may be accessed to grant access to the content and/or control display (e.g., format, etc.) of content. Thus, an embodiment of the present invention may use detailed knowledge of the host application to provide for more specific content that may be further tailored to a user, type of user and/or other criteria.

Content association may be provided for object names, as well as the values contained within the objects. For example, if a field object called “name” contains the value “John Doe,” content may be associated with the field value so that the content is displayed when the field object contains the value “John Doe.”

Content association may be provided for non-interactive parts of the page. The proxy server may insert code into the host application for identifying text or other element on an application page and provide a similar interface to the content server that it does for interactive parts of the page. This would also allow content to be associated with field labels. For example, when the words “Today's Specials” appear on the host application page and the user mouses over the text, a list of sale items may appear in the content window. In another example, the content may be embedded within the application page. Other display options are available.

User and/or security information in the host application may be accessed to grant access to content and/or control display of content. Information may be accessed from other sources (e.g., external database, manual input, automatic extraction of data, other applications, etc.). For end users of an embodiment of the present invention, content may be filtered based on a user's security, set of permissions to the host application and/or based on other information. Therefore, content delivered to a user may be user-sensitive.

According to another exemplary scenario, a multi-divisional company may use a single enterprise software package for most of its back-end accounting functions across divisions. The divisions within the company may sell different products, but may be required to use the same software to report their sales. The enterprise software may be implemented so that the divisions may use the software. The end users of the enterprise software may be assigned to groups based on the division they belong to as well as their job functions (and/or other consideration). The usage of an accounts receivable portion of the software may vary from division to division, even though the screens are substantially the same. Therefore, the associated content delivered by an embodiment of the present invention may be different for each division based on the differences in business processes among the divisions. Other considerations, e.g., security levels, user preferences, etc., may adjust the content displayed to each division and/or each user.

An embodiment of the present invention may gain access to security groups set up in the enterprise software. This information may be used to display the appropriate set of content to each group of users based on their group membership, where they are in the enterprise software and/or other considerations. For developers of content, access to the host application's security set up may allow for a single sign-in to the host application that would also pass through to an associated development toolbox.

Another iteration of the present invention may include client-side capture of pages and/or other data at the content server. An embodiment of the present invention provides for the ability to detect pages automatically as they load in the host application window. Thus, a user's path through a system or application may be captured. The capture feature may also identify elements within a page as well as an entire page. This information may be stored for a variety of possible uses, such as saving a list of pages, frameset page detection, automatic documentation generation, user task analysis, content organization and/or other uses.

For example, a list of pages may be saved as the pages stream by. A user may activate a capture capability which may accumulate the names (or other identifiers) and/or URLs of the host application's HTML pages as they load in the browser. These pages can be selected from a list and saved for content annotation. Frameset page detection may involve detecting pages to identify some or all the pages contained within a frameset (or other grouping of pages) as they load.

Automatic generation of workflow documentation may use predefined templates for style and format. For automatic documentation generation, as pages (e.g., HTML pages) in the host application load in the browser, user activity may be captured. User activity may involve what mouse clicks a user makes, what fields a user tabs into, where a user browses to, how often an object is accessed, the order objects are accessed, etc. Other user activity may be tracked. This information may be saved and used to generate content based on a set of pre-defined templates for the various types of user activities.

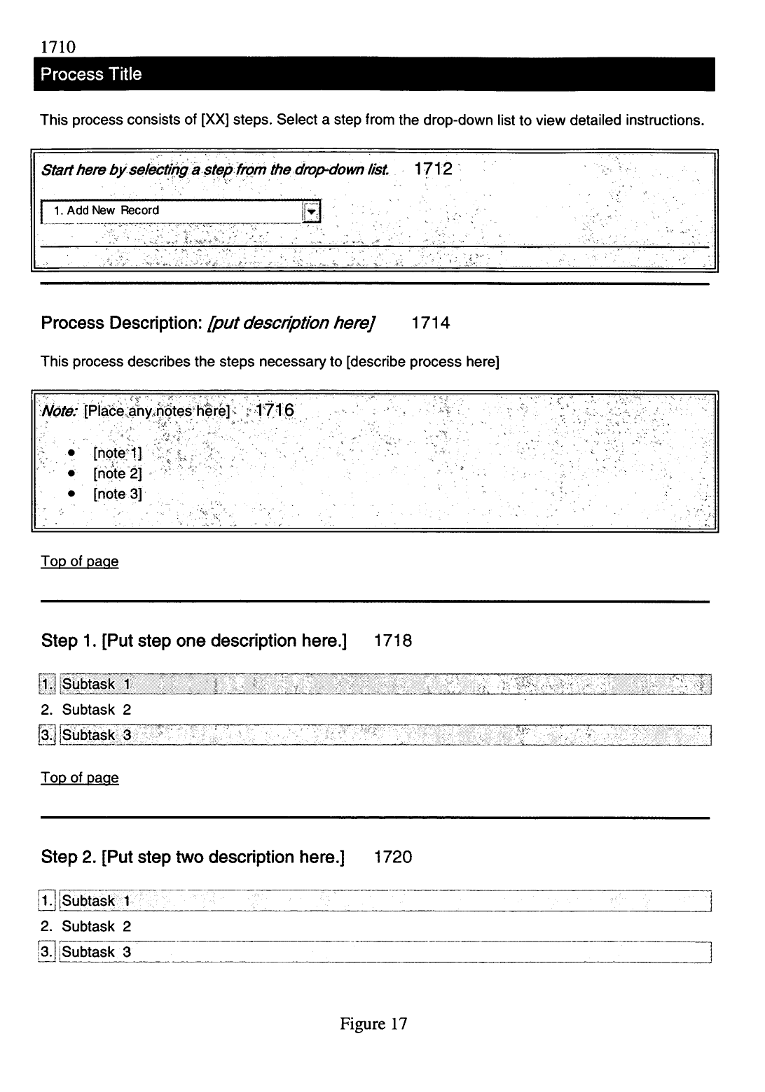

FIG. 17 is an exemplary template for automatic documentation generation, according to an embodiment of the present invention. Process title 1710 may identify a process, which may include a plurality of steps. At 1712, a step may be selected from a drop-down list where detailed instructions may be displayed. For example, in a process for maintaining employee records, exemplary steps may include add a new record, enter employee details and assign the employee to a division/department. Process Description 1714 may provide a description of the process, which may include goals, objectives, etc. Notes 1716 may be included. Other data may also be incorporated. Various steps may be included, such as Step 1 1718 and Step 1 1720. Each step may have additional subtasks and/or other subsets of data. For example, the content generated may become the basis for developing procedural documentation, workflows and/or other purpose. The information may be saved in one or more databases (or other memory or storage mechanism) and accessed by an embodiment of the present invention just as any other content is accessed and displayed.

For user task analysis, user usage of pages may be monitored. This data may be used to determine where and how to target content. For content feedback loop, recommendations on where to focus content updates may be created based on user paths through an application or a system. For example, an embodiment of the present invention may monitor usage of certain host application pages. Based on the amount, type, or other measure of activity, this information may be used to report on the most likely places to provide assistive content. This information may also provide a feedback loop for providing recommendations on where to focus content updates based on user paths through system or other measure of user activity.

For content organization, potential common (e.g., global) content may be analyzed and recommendations for content organization may be generated by using the path the user navigates to inspect the application. An embodiment of the present invention may capture user paths through the host application and analyze the system for potential common (e.g., global) content. Recommendations may then be generated for content organization.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breadth and spirit of the present invention as disclosed herein.

1. A computer implemented method for associating content with one or more application objects, the method comprising the steps of:
intercepting an application page from an application server to a client browser for displaying the application page;
identifying one or more application objects associated with the application page, wherein the one or more application objects comprise one or more of tagged objects and non-tagged objects;
identifying the one or more application objects wherein the one or more applications objects are associated with content by an object identifier;
associating the object identifier to the one or more application objects; and
sending the application page to the client browser wherein an appropriate content identified by the object identifier is displayed when an associated application object is triggered in the application page displayed on the client browser.

2. The method of claim 1, wherein the step of associating further comprises the steps of:
associating the object identifier to the one or more tagged objects; and
identifying to a content server that the one or more non-tagged objects exist.

3. The method of claim 1, wherein the content displayed in response to the application object triggered in the application page is embedded into the application page.

4. The method of claim 3, wherein the content is embedded as one or more of text, audio, layers and alt text.

5. The method of claim 1, wherein the content is displayed on one or more remote devices.

6. The method of claim 1, wherein the one or more application objects are associated with a field value of the content.

7. The method of claim 1, further comprising the step of:
identifying security information for granting access to content data.

8. The method of claim 1, further comprising the step of:
identifying security information for controlling display of content data.

9. The method of claim 1, further comprising the step of:
detecting one or more pages identified by a page identifier as the application pages load in an application window.

10. The method of claim 9, further comprising the step of:
identifying user activity data for generating content based on a set of predefined templates for user activity.

11. The method of claim 9, further comprising the step of:
monitoring user usage of the one or more detected pages for determining where to target content data.

12. The method of claim 9, further comprising the step of:
identifying a user navigation path through the one or more application pages.

13. A method employed by a computer user for accessing content associated with one or more application objects, the method comprising the steps of:
accessing an application page from an application server, wherein the application page is intercepted by a proxy server, prior to displaying the application page on a client browser;
wherein the proxy server identifies one or more application objects associated with the application page, the one or more application objects comprising one or more of tagged objects and non-tagged objects,
wherein the proxy server identifies the one or more application objects wherein the one or more applications objects are associated with content by an object identifier;
triggering an application object displayed on the application page on the client browser; and
viewing content identified by the object identifier when the associated application object is triggered.

14. The method of claim 13, further comprising the steps of:
associating the object identifier to the one or more tagged objects; and
associating the object identifier to the one or more non-tagged objects through an interface to an API.

15. The method of claim 13, wherein the content displayed in response to the application object triggered in the application page is embedded into the application page.

16. The method of claim 15, wherein the content is embedded as one or more of text, audio, layers and alt text.

17. The method of claim 13, wherein the content is displayed on one or more remote devices.

18. The method of claim 13, wherein the one or more application objects are associated with a field value of the content.

19. The method of claim 13, wherein security information is identified for granting access to content data.

20. The method of claim 13, wherein security information is identified for controlling display of content data.

21. The method of claim 13, wherein one or more pages identified by a page identifier is detected as the application pages load in an application window.

22. The method of claim 21, wherein user activity data is identified for generating content based on a set of predefined templates for user activity.

23. The method of claim 21, wherein user usage of the one or more detected pages is monitored for determining where to target content data.

24. The method of claim 21, wherein a user navigation path through the one or more application pages is identified.

25. A computer implemented method for associating content with an application, the method comprising the steps of:
loading an application page through a proxy server;
embedding javascript in the application page for activating a content window;
verifying that a media object is present and a help/training tool is enabled;
loading the media object through an additional media object that implements an API; and
displaying context sensitive content in the content window in response to a user input in the media object.

26. The method of claim 25, wherein the media object is a Flash movie.

27. The method of claim 25, wherein the application is divided into a plurality of subsets.

28. The method of claim 25, wherein one or more functions are embedded in a subset.

29. The method of claim 28, wherein one of the one or more functions calls the API to the help/training tool.

30. The method of claim 28, wherein one of the one or more functions provides a list of objects for associating content with one or more objects.

31. A computer implemented system for associating content with one or more application objects, the system comprising:
a proxy server for intercepting an application page from an application server to a client browser for displaying the application page; identifying one or more application objects associated with the application page, wherein the one or more application objects comprise one or more of tagged objects and non-tagged objects; identifying the one or more application objects wherein the one or more applications objects are associated with content by an object identifier; and associating the object identifier to the one or more application objects; and
the client browser for receiving the application page wherein an appropriate content identified by the object identifier is displayed when an associated application object is triggered in the application page displayed on the client browser.

32. The system of claim 31, wherein the proxy server associates the object identifier to the one or more tagged objects and identifies to a content server that the one or more non-tagged objects exist.

33. The system of claim 31, wherein the content displayed in response to the application object triggered in the application page is embedded into the application page.

34. The system of claim 33, wherein the content is embedded as one or more of text, audio, layers and alt text.

35. The system of claim 31, wherein the content is displayed on one or more remote devices.

36. The system of claim 31, wherein the one or more application objects are associated with a field value of the content.

37. The system of claim 31, wherein security information for granting access to content data is identified.

38. The system of claim 31, wherein security information for controlling display of content data is identified.

39. The system of claim 31, wherein one or more pages identified by a page identifier are detected as the application pages load in an application window.

40. The system of claim 39, wherein user activity data for generating content based on a set of predefined templates for user activity is identified.

41. The system of claim 39, wherein user usage of the one or more detected pages for determining where to target content data is monitored.

42. The system of claim 39, wherein a user navigation path through the one or more application pages is identified.

43. A system employed by a computer user for accessing content associated with one or more application objects, the system comprising:
an application server for accessing an application page,
a proxy server for intercepting the application page, prior to displaying the application page on a client browser; wherein the proxy server identifies one or more application objects associated with the application page, the one or more application objects comprising one or more of tagged objects and non-tagged objects, and wherein the proxy server identifies the one or more application objects wherein the one or more applications objects are associated with content by an object identifier;
a user device for triggering an application object displayed on the application page on the client browser; and
a display for viewing content identified by the object identifier when the associated application object is triggered.

44. The system of claim 43, wherein the proxy server associates the object identifier to the one or more tagged objects; and identifies to a content server that the one or more non-tagged objects exist.

45. The system of claim 43, wherein the content displayed in response to the application object triggered in the application page is embedded into the application page.

46. The system of claim 45, wherein the content is embedded as one or more of text, audio, layers and alt text.

47. The system of claim 43, wherein the content is displayed on one or more remote devices.

48. The system of claim 43, wherein the one or more application objects are associated with a field value of the content.

49. The system of claim 43, wherein security information is identified for granting access to content data.

50. The system of claim 43, wherein security information is identified for controlling display of content data.

51. The system of claim 43, wherein one or more pages identified by a page identifier is detected as the application pages load in an application window.

52. The system of claim 51, wherein user activity data is identified for generating content based on a set of predefined templates for user activity.

53. The system of claim 51, wherein user usage of the one or more detected pages is monitored for determining where to target content data.

54. The system of claim 51, wherein a user navigation path through the one or more application pages is identified.

55. A computer implemented system for associating content with an application, the system comprising:
a proxy server for loading an application page; and embedding javascript in the application page for activating a content window; where whether a media object is present and a help/training tool is enabled are verified;
an additional media object for loading the media object wherein the additional media object implements an API; and
the content window for displaying context sensitive content in response to a user input in the media object.

56. The system of claim 55, wherein the media object is a Flash movie.

57. The system of claim 55, wherein the application is divided into a plurality of subsets.

58. The system of claim 55, wherein one or more functions are embedded in a subset.

59. The system of claim 58, wherein one of the one or more functions calls the API to the help/training tool.

60. The system of claim 58, wherein one of the one or more functions provides a list of objects for associating content with one or more objects.
